(19) United States
(12) Patent Application Publication
(10) Pub. No.: US 2008/0202434 A1
(43) Pub. Date: Aug. 28, 2008

(54) Pet comfort composite material

(76) Inventor: Vickie Arnold, Edgerton, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 11/711,348

(22) Filed: Feb. 27, 2007

(51) Int. Cl. A01K 29/00

(52) U.S. Cl. 119/28.5; 119/850

(57) ABSTRACT

A pet comfort composite material for use in pet bedding, animal blankets, and other animal-related uses comprised of: a wicking layer having a top and bottom surface and adapted to allow moisture to migrate into the pet comfort composite material and away from the top surface; an absorbing layer having a top and bottom surface, the top surface of which is adjacent to the bottom surface of the wicking layer and adapted to absorb said moisture; and a protecting layer having a top and bottom surface, the top surface being adjacent to the bottom surface of said absorbing layer and adapted to prevent moisture from passing through said protecting layer. In one embodiment, the wicking layer is a series 100 fleece fabric as manufactured by Malden Mills®, the absorbing layer is a layer a cotton/terry Sherpa™ from the American Terry Co.®, and the protecting layer is a layer of 200 fleece series fabric as manufactured by Malden Mills®.

### FIELD OF INVENTION

This invention relates generally to the field of animal supplies, and in particular to the field of pet comfort composite material having multiple layers to draw moisture away from the pet and keep the moisture from coming in contact with the floor below the pet and bedding.

### BRIEF DESCRIPTION OF THE DRAWINGS

FIG. 1 shows a top perspective view of one embodiment of the pet comfort material in use with a dog.

FIG. 2 shows a cross-sectional side view of one embodiment of the pet comfort composite material being used as bedding, as taken along line 2-2 in FIG. 1.

FIG. 3 shows a cross-sectional side view of an alternate embodiment of the pet comfort composite material in which the wicking layer and the protecting layer are substantially equal in dimensions, but the middle or absorbing layer is slightly smaller.

FIG. 4 shows the pet comfort composite material being used as a horse blanket.

FIG. 5 shows the pet comfort composite material being used as dog clothing.

### BACKGROUND

Pets and other domesticated animals may become wet during transport, exercise, or recreation, or from urination, and it is desirable to have clothing, bedding, and comfort items made from a material which reduces the level of moisture that comes in contact with the animal or increases the animal's level of comfort. The present invention provides an improved material for use for items made for domestic animals.

As used herein, “absorbing” refers to taking moisture or other liquid in through or as through pores or interstices and holding the moisture, and “absorbing layer” refers to any layer or layers of material that absorbs.

As used herein, “animal” refers to any pet, domesticated animal, or animal raised or maintained for an economic or recreational purpose.

As used herein, “bedding” refers to any blanket, quilt, sheets, or any other fabric or material on which an animal might sleep or rest.

As used herein, “pet comfort material” or “pet comfort composite material” refers to a material or combination of materials adapted to increase pet comfort and may exhibit factors such as limiting moisture in contact with the pet, maintaining the pet's body temperature, or providing increased pet comfort in any manner. This term further refers to material which may be adapted to pet bedding, clothing, covering, lining, or other pet items.

As used herein, “protecting layer” refers to any layer or layers of material that prevents all or a portion of moisture from passing through it.

As used herein, “water-resistant” is intended to be generic to materials that are water resistant as well as those materials that are waterproof.

As used herein, “wicking” refers to drawing, pulling, or allowing moisture to be drawn or pulled through a material, whether all or a portion of the moisture, and “wicking layer” refers to any layer or layers of material that wicks.

### Detailed Description of Embodiments of the Invention

For the purpose of promoting an understanding of the present invention, references are made in the text hereof to embodiments of a pet comfort composite material, only some of which are depicted in the figures. It should nevertheless be understood that no limitations on the scope of the invention are thereby intended. One of ordinary skill in the art will readily appreciate that modifications such as the dimensions, size, and shape of the components, alternate but functionally similar materials from which the pet comfort composite material is made, and the inclusion of additional elements are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed bedding, apparatus, or manner.

It should be understood that the drawings are not necessarily to scale, emphasis instead being placed upon illustrating the principles of the invention. In addition, in the embodiments depicted herein, like reference numerals in the various drawings refer to identical or near indentical structural elements.

Moreover, the term “substantially” or “approximately” as used herein may be applied to modify any quantitative representation that could permissibly vary without resulting in a change in the basic function to which it is related. For example, one embodiment of the pet comfort composite material is disclosed herein as being being used as dog bedding and formed in to a rectangular shape. The beddinging might permissibly be somewhat non-rectangular or ovular and still be within the scope of the invention if its functionality is not materially altered.

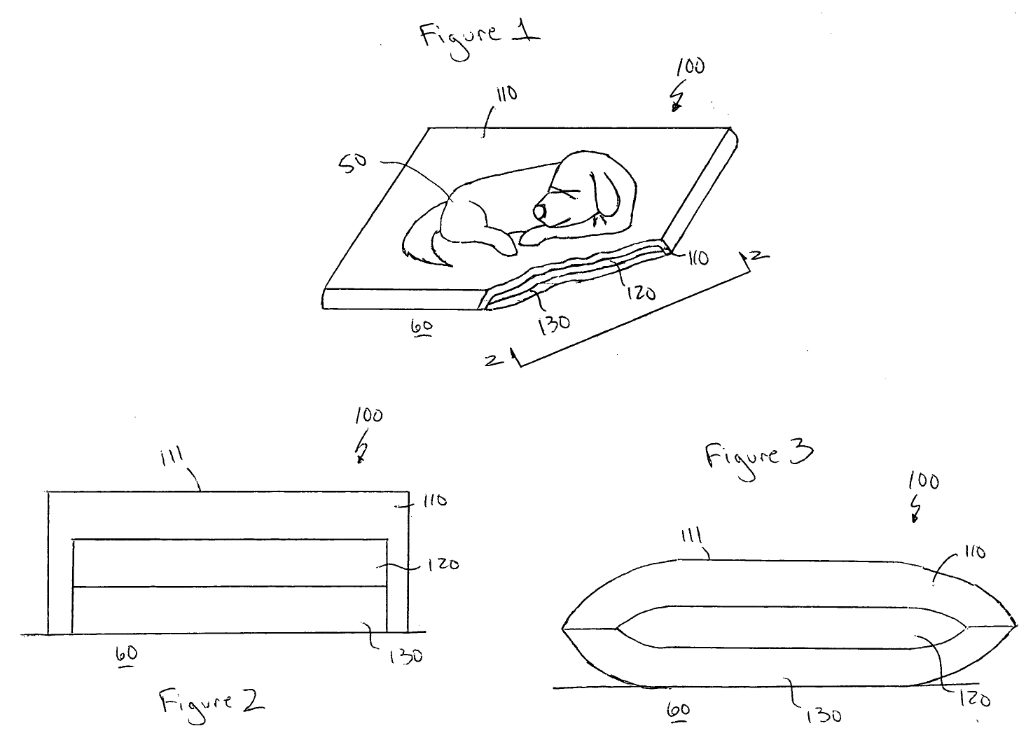

Referring now to the drawings, FIG. 1 shows a top perspective view of one embodiment of pet comfort composite material 100 being used as pet bedding with dog 50 resting thereupon, with a portion cut out to show the layers from which this embodiment of pet comfort composite material 100 is made. In the embodiment shown, pet comfort composite material 100 is comprised of three (3) layers: wicking layer 110, absorbing layer 120, and protecting layer 130. In the embodiment shown, the pet bedding made of pet comfort composite material 100 is formed in a substantially rectangular shape. However, it should be understood that the pet bedding can be any alternate shape, e.g., ovular. It should be understood that the pet bedding made of pet comfort composite material 100 can be made into substantially any shape and can further include decorations or adornments as well as be of any or multiple colors.

FIG. 2 shows a cross-sectional side view of the embodiment of a pet bedding, made of pet comfort composite material 100, shown in FIG. 1 taken along line 2-2. Although not shown to scale, wicking layer 110, absorbing layer 120, and protecting layer 130 can all be appreciated. When the pet (not shown) is on top of pet comfort composite material 100 and pet comfort composite material 100 is subject to moisture, wicking layer 110 pulls moisture down into pet comfort composite material 100, away from top surface 111 of wicking layer 110 and the pet to absorbing layer 120. Wicking layer 110 is thick enough to prevent the moisture from migrating back up to top surface 111 of wicking layer 110 and is also soft enough for comfort of the pet. In an alternate embodiment, wicking layer 110 is also elastic. In the embodiment shown, wicking layer 110 is series 100 fleece fabric from Maiden Mills®. However, wicking layer 110 can be of any alternate material that exhibits similar characteristics.

Also shown in FIG. 2 is absorbing layer 120. Absorbing layer 120 absorbs and holds the moisture pulled down from wicking layer 110 above it. Once the pet moves off of pet comfort composite material 100, moisture within absorbing layer 120 is allowed to evaporate. In the embodiment shown, absorbing layer 120 is a cotton/terry Sherpa™ from American Terry Co.®. This material gets softer and more absorbent as it is washed and dried. However, absorbing layer 120 can be of any alternate material that exhibits similar characteristics.

Also shown in FIG. 2 is protecting layer 130. Protecting layer 130 is made of a water resistant material that prevents moisture held within absorbing layer 120 from migrating from absorbing layer 120 to surface 60 below pet comfort composite material 100. Protecting layer 130 is the bottom-most layer, thus keeping the moisture within absorbing layer 120 until it can evaporate. In the embodiment shown, protecting layer 130 is 200 fleece series fabric as manufactured by Maiden Mills® and treated with a water-repellant finish. However, absorbing layer 120 can be of any alternate material that exhibits similar characteristics.

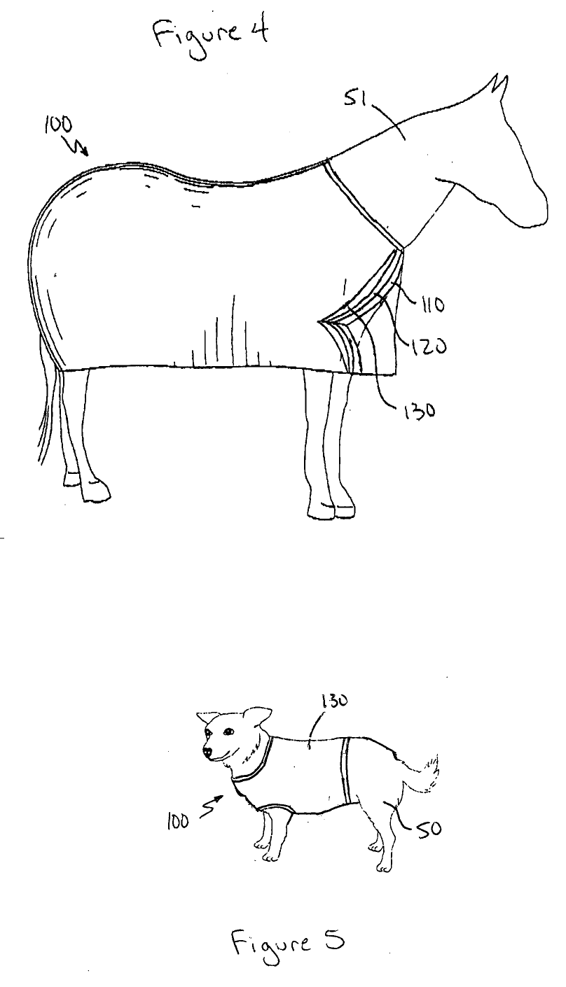

In the embodiment shown, wicking layer 110 is larger than absorbing layer 120 and protecting layer 130 such that it wraps around the side surfaces of absorbing layer 120 and protecting layer 130. However, FIG. 3 shows a cross-sectional view of an alternate embodiment of pet comfort composite material 100 in which wicking layer 110 and protecting layer 130 are substantially equal in dimensions, both larger than absorbing layer 120 and enclosing absorbing layer 120 between them. As a further alternate embodiment of pet comfort composite material 100, each layer, i.e., wicking layer 110, absorbing layer 120, and protecting layer 130, can each be substantially equal in dimensions.

In both embodiments of pet comfort composite material 100 shown in FIGS. 2 and 3, wicking layer 110, absorbing layer 120, and protecting layer 130 are sewn to one another. Each of wicking layer 110, protecting layer 130, and absorbing layer 120 are cut slightly larger than necessary to form pet comfort composite material 100 to allow each layer 110, 120, 130 to be trimmed and squared up during sewing. After cutting, each layer 110, 120, 130 is serged using an industrial machine for all four (4) sides to prevent fraying and/or unraveling. Pet comfort composite material 100 is then further secured by adding straight line stitching to help secure layers 110, 120, 130 in place. A final step secures the threads at the corners to further prevent pet comfort composite material 100 from unraveling. However, it should be understood that any means of connecting wicking layer 110, absorbing layer 120, and protecting layer 130 to one another that prevents fraying and/or unraveling, including methods other than sewing, can be used.

FIG. 4 shows an alternate use of pet comfort composite material 100 in which pet comfort composite material 100 is used as a horse blanket to cover horse 51. The horse blanket is pulled back so that a cross-section of pet comfort composite material 100 is visible. In this embodiment, pet comfort composite material 100 is again formed of wicking layer 110, absorbing layer 120, and protecting layer 130. Wicking layer 110 is the innermost layer, adjacent to horse 51, and absorbing layer 120 is again the middle layer. However, pet comfort composite material 100 is constructed with protecting layer 130 as the top or outermost layer to prevent or minimize the amount of water from the environment, e.g., rain water, from contacting horse 51. It should be understood that horse 51 is just one example of an animal in which pet comfort composite material 100 can be used to construct a blanket.

FIG. 5 shows pet comfort composite material 100 being used as clothing for dog 50. Although each individual layers is not shown, as with the embodiment of pet comfort composite material 100 used as a horse blanket in FIG. 4, the dog's 50 sweater is made of pet comfort composite material 100 comprised of a wicking layer, an absorbing layer, and protecting layer 130, in which the wicking layer is adjacent to cat 52, the absorbing layer is the middle layer, and protecting layer 130 is the outermost layer to prevent or minimize the amount of environmental moisture from entering pet comfort composite material 100.

While pet comfort composite material 100 has been shown and described with respect to several embodiments and uses in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

What is claimed is:

1. A pet comfort composite material comprised of:
a wicking layer, said wicking layer having a top surface and a bottom surface, said wicking layer adapted to allow moisture to migrate into said pet comfort composite material and away from said top surface;
an absorbing layer, said absorbing layer comprised of a top surface and a bottom surface, said top surface of said absorbing layer adjacent to said bottom surface of said wicking layer and adapted to absorb said moisture; and
a protecting layer, said protecting layer having a top surface and a bottom surface, said top surface adjacent to said bottom surface of said absorbing layer and adapted to prevent said moisture from passing through said protecting layer.

2. The pet comfort composite material of claim 1, wherein said wicking layer, said absorbing layer, and said protecting layer are each sewn together by a stitch selected from a group comprised of serging and straight line stitching.

3. The pet comfort composite material of claim 1, wherein said pet comfort composite material is for use selected from a group comprised of an animal bedding, a blanket, and an article of animal clothing.

4. The pet comfort composite material of claim 1, wherein said pet comfort composite material is adapted for use by at least one animal,

5. The pet comfort composite material of claim 1, wherein said wicking layer is a series 100 fleece fabric as manufactured by Malden Mills.

6. The pet comfort composite material of claim 1, wherein said absorbing layer is a cotton/terry Sherpa as manufactured by American Terry Company.

7. The pet comfort composite material of claim 1, wherein said protecting layer is a 200 fleece series fabric as manufactured by Malden Mills and treated with a water-repellant finish.

8. A water-resistant composite material for use as a pet bedding comprised of:
a top layer, said top layer having a top surface and a bottom surface, said top layer adapted to draw moisture down into said pet bedding and away from said top surface;
a middle layer, said middle layer positioned below said top layer and adapted to absorb said moisture; and
a bottom layer, said lower positioned below said middle layer and adapted to prevent said moisture from migrating from said middle layer to a surface below said pet bedding.

9. The composite material of claim 8, wherein said top layer, said middle layer, and said bottom layer are each sewn together by a stitch selected from a group comprised of serging and straight line stitching.

10. The composite material of claim 8, wherein said pet bedding is of a shape selected from a group comprised of a rectangular and an oval.

11. The composite material of claim 8, wherein said pet bedding is adapted for use by at least one pet.

12. The composite material of claim 8, wherein said top layer is a series 100 fleece fabric as manufactured by Malden Mills.

13. The composite material of claim 8, wherein said middle layer is a cotton/terry Sherpa as manufactured by American Terry Company.

14. The composite material of claim 8, wherein said bottom layer is a 200 fleece series fabric as manufactured by Malden Mills and treated with a water-repellant finish.

15. An animal comfort composite material for use by an animal comprised of:
a layer of series 100 fleece fabric as manufactured by Malden Mills, said layer of series 100 fleece fabric having a top surface and a bottom surface, said layer of series 100 fleece fabric adapted to draw moisture down into said apparatus and away from said top surface;
a layer a cotton/terry Sherpa from American Terry Co., said layer a cotton/terry Sherpa positioned adjacent to said layer of series 100 fleece fabric and adapted to absorb said moisture; and
a layer of 200 fleece series fabric as manufactured by Malden Mills, said layer of 200 fleece series fabric positioned adjacent to said layer a cotton/terry Sherpa and adapted to prevent said moisture from passing through said animal comfort composite material.

16. The animal comfort composite material of claim 15, wherein said layer of series 100 fleece fabric, said layer a cotton/terry Sherpa, and said layer of 200 fleece series fabric are each sewn together by a stitch selected from a group comprised of serging and straight line stitching.

17. The animal comfort composite material of claim 15, wherein said animal comfort composite material is for use selected from a group comprised of an animal bedding, a blanket, and an article of animal clothing.

18. The animal comfort composite material of claim 15, wherein said layer of 200 fleece series fabric as manufactured by Malden Mills is treated with a water-repellant finish.
